(19) United States
(12) Patent Application Publication
(10) Pub. No.: US 2008/0303669 A1
(43) Pub. Date: Dec. 11, 2008

(54) Vibration logging tag

(75) Inventor: Philip Lazo, Mount Airy, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/808,364

(22) Filed: Jun. 8, 2007

(51) Int. Cl. G08B 13/14

(52) U.S. Cl. 340/572.1

(57) ABSTRACT

A method for tracking vibrational information for an item via an RFID tag is provided. The method includes interrogating the RFID tag at various points throughout the supply chain to obtain vibrational entries for the RFID tag. The vibrational entries are then individually compared to a set of thresholds. The sum of the one or more vibrational entries may also be compared to a different set of thresholds. A designation for the item (e.g., non-operational, potentially damaged, normal) is then assigned based on the results of the comparison.

### FIELD OF THE INVENTION

The invention relates to radio frequency identification (RFID) technology, and in particular, to sensing conditions using RFID tags.

### BACKGROUND OF THE INVENTION

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed a “reader interrogator” or simply “interrogator”.

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

In addition to monitoring the presence of an item, it is often desirable to sense a condition of the item, such as its exposure to extreme temperatures. Often times such conditions are measured by measuring ambient conditions or the conditions of a subset of the total number of items. Typically, measuring the conditions of each individually becomes increasingly inefficient and costly as the number of items grows.

Thus, what is needed is way to remotely sense a condition of an item in a cost effective manner.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where radio frequency identification (RFID) readers communicate with an exemplary population of RFID tags.

FIG. 2 shows a block diagram of receiver and transmitter portions of a RFID reader.

FIG. 3A shows a block diagram of a plan view of an example RFID tag.

FIG. 3B shows a top view of an example RFID tag.

FIG. 4 shows a top view of an RFID tag, according to an embodiment of the present invention.

FIG. 5 shows a system for monitoring an item, according to an embodiment of the present invention.

FIG. 6 shows a flowchart providing example steps for monitoring an item, according to an example embodiment of the present invention.

FIG. 7 shows another flowchart providing example steps for monitoring an item, according to an example embodiment of the present invention

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

Methods, systems, and apparatuses for improved vibration sensing RFID tags are described herein. The vibration sensing tags described herein provide a way to remotely sense vibration.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up, ” “down,” “top,” “bottom,” “vertical,”“horizontal,” etc.) used herein are for purposes of illustration only, and that practical implementations of the structures described herein can be spatially arranged in any orientation or manner.

### Example RFID System Embodiment

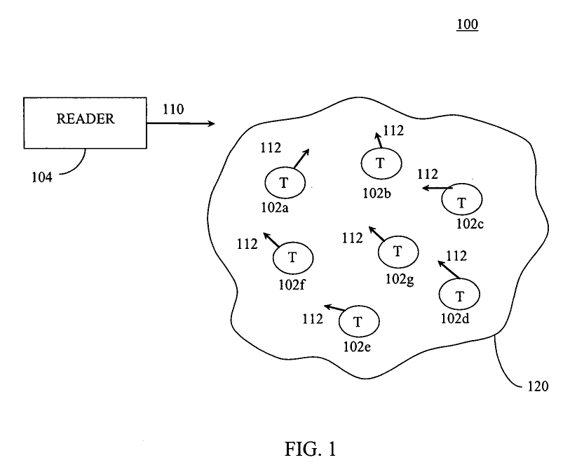

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes one or more readers 104. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, reader 104 transmits an interrogation signal 110 having a carrier frequency to the population of tags 120. Reader 104 operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, such as an identification number of the responding tag 102. In the embodiments described herein, a reader may be capable of communicating with tags 102 according to any suitable communication protocol, including binary traversal protocols, slotted aloha protocols, Class 0, Class 1, EPC Gen 2, any others mentioned elsewhere herein, and future communication protocols.

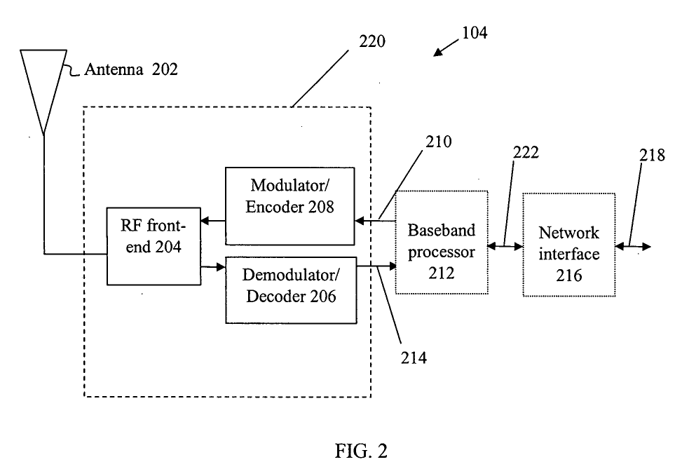

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FMO or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

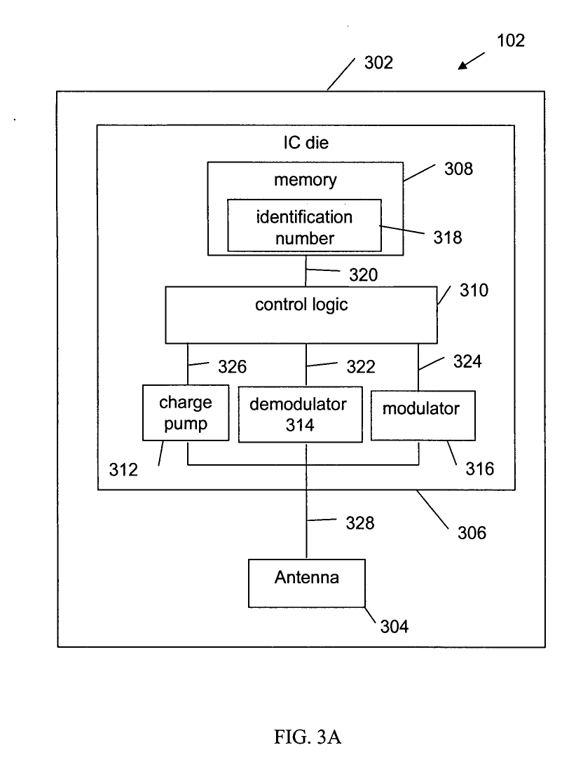

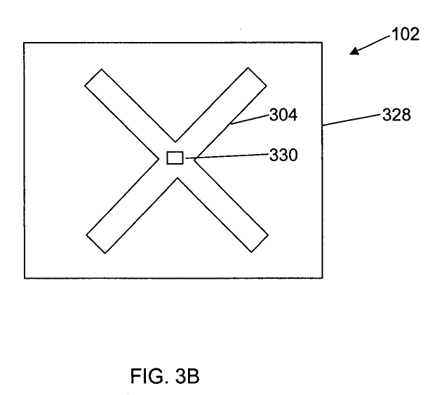

The present invention is applicable to any type of RFID tag. FIG. 3A shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

FIG. 3B shows a top view of an example of tag 102. Tag 102 includes a substrate 302, antenna 304, and an electrical circuit 330. Electrical circuit 330 may include elements one or more elements of IC 306 shown in FIG. 3A. Electrical circuit 330 also may store an identification code that identifies tag 102. Electrical circuit 330 may be commercially available as a single integrated circuit or may have separate components that are assembled with tag 102.

Example embodiments of the present invention are described in further detail below. Such embodiments may be implemented in the environments and readers described above, and/or in alternative environments and alternative RFID devices.

### Example Embodiments for Vibration Sensing RFID Tags

The example embodiments described herein are provided for illustrative purposes, and are not limiting. The examples described herein may be adapted to any type of RFID communication. Further structural and operational embodiments, including modifications/alterations, will become apparent to persons skilled in the relevant art(s) from the teachings herein.

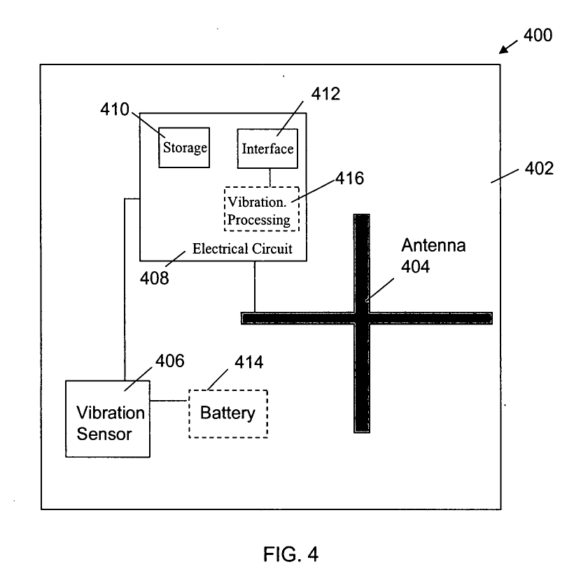

FIG. 4 shows a top view of an RFID tag 400, according to an embodiment of the present invention. RFID tag 400 includes a substrate 402, an antenna 404, a vibration sensor 406, and an electrical circuit 408. RFID tag 400 also optionally includes a battery 414. Substrate 402 may be a variety of different types of substrates such as a flex-tape substrate or FR-4, as would be understood by someone skilled in the relevant art(s).

As shown in FIG. 4, antenna 404 is a dual dipole antenna. In alternate embodiments, however, antenna 404 may be other antenna types such as a dipole antenna, a loop antenna, or a patch antenna. In an embodiment, antenna 404 is configured to receive RFID interrogation signals and to transmit responses to RFID interrogation signals. In an embodiment, antenna 404 transmits response signals by backscattering received RFID interrogation signals.

Vibration sensor 406 senses vibration and outputs a sensor output signal that contains the vibration information. A vibration of a device or item refers to an event in which one or more mechanical forces are applied to the device or item such that the device or item may experience a change in shape, orientation, and/or position. This change may be temporary or permanent. In an embodiment, vibration sensor 406 includes a piezoelectric crystal. When a piezoelectric crystal is exposed to a mechanical force or stress, the crystal develops a voltage. Vibration sensor 406 outputs an analog voltage signal which is substantially proportional to a sensed vibration. If tag 400 is perfectly still, vibration sensor 406 may output a corresponding signal (e.g., ground). As would be appreciated by persons of skill in the art, vibration sensor 406 may be configured to output a digital signal.

Electrical circuit 408 is electrically coupled to vibration sensor 406 and antenna 404. Electrical circuit 408 includes a storage 410 and a sensor interface circuit 412. Sensor interface circuit 412 receives a sensor output signal from vibration sensor 406 and generates an output signal that is received by storage 410. In an embodiment, sensor interface circuit 412 is an analog-to-digital converter that receives an analog signal including the sensed vibration information from vibration sensor 406 and generates a corresponding digital signal. Sensor interface circuit 412 may be configured to sample the output of vibration sensor 406 at discrete time periods. Storage 410 may then be configured such that each output from sensor interface 412 occupies an entry in storage 410. Alternatively, storage 410 may be configured to store a subset of outputs from sensor interface 412. A stored output from sensor interface 412 is referred to as a sensed vibration entry.

Electrical circuit 408 may also include a vibration processor 416. Vibration processor 416 may perform a variety of processing on the stored sensed vibration entries. For example, vibration processor 416 may compare a sensed vibration entry or a combination of sensed vibration entries stored in storage 410 to one or more thresholds. Based on the comparison results, vibration processor 416 may determine a status of tag 400 or an item to which tag 400 is attached. In alternate embodiments, processing of sensed vibration entries may occur at a reader or a central network location.

Battery 414, when present, is used to power vibration sensor 406 and/or tag 400. Battery 414 may be any type of battery such as a lithium ion battery or any other suitable battery as would be understood by person(s) skilled in the relevant art(s).

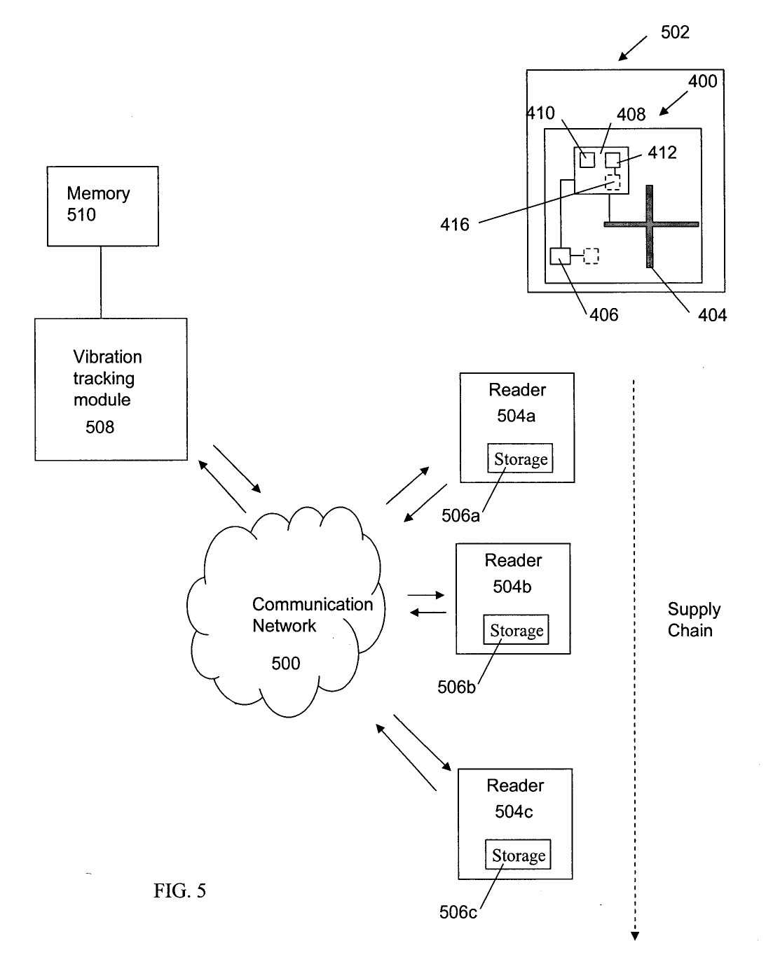

FIG. 5 shows a system for monitoring an item in a supply chain, according to an embodiment of the present invention. FIG. 5 shows a communication system 500, an item 502 with an affixed RFID 400, readers 504a-c, and a vibration tracking module 508. Communication system 500 may be a wireless network, the public switched telephone network, a public or private data network, or any combination thereof, as would be understood by persons skilled in the relevant art(s). Item 502 may be a consumer good, appliance, or other product that may require vibration monitoring. For example, certain consumer products may be damaged by exposure to excessive vibrations during movement through the supply train. A vibration tag 400 may be affixed to these items (or other items) to identify items potentially damaged prior to sale to a customer. Readers 504a-c may monitor item 502 at different stages of a supply train. For example, reader 504a may monitor item 502 during assembly at a manufacturing location and reader 504b may be included in a delivery means, e.g. a delivery truck, cargo ship, etc., that is used to deliver item 502 to a destination and monitor item 502 during delivery. Reader 504c may monitor item 502 while in inventory at the retailer or wholesaler. Readers 504a-c are configured to interrogate RFID tag 400 to obtain identity, sensed vibration data, and possibly additional information about an item. Readers 504a-504c may store vibration entries received in communications with tag 400 in storage 506a-506c.

Vibration tracking module 508 is coupled to a memory 510. Memory 510 may be external to vibration tracking module 508 or may be included in vibration tracking module 508. Memory 510 may be used to store sensed vibration entries sensed by tag 400. In an embodiment, vibration tracking module 508 communicates with readers 504a-504c to obtain sensed vibration entries. Vibration tracking module 508 is configured to process sensed vibration entries to determine the status of item 502 having an affixed vibration tag. For example, vibration tracking module 508 may be configured to sum a number of sensed vibration entries for a tag and compare that sum to a threshold or a series of thresholds. Additionally, one or more of the vibration entries may be weighted. In addition or alternatively, vibration tracking module 508 may compare individual sensed vibration entries for a tag to one or more thresholds to determine if any individual entry exceeds a threshold.

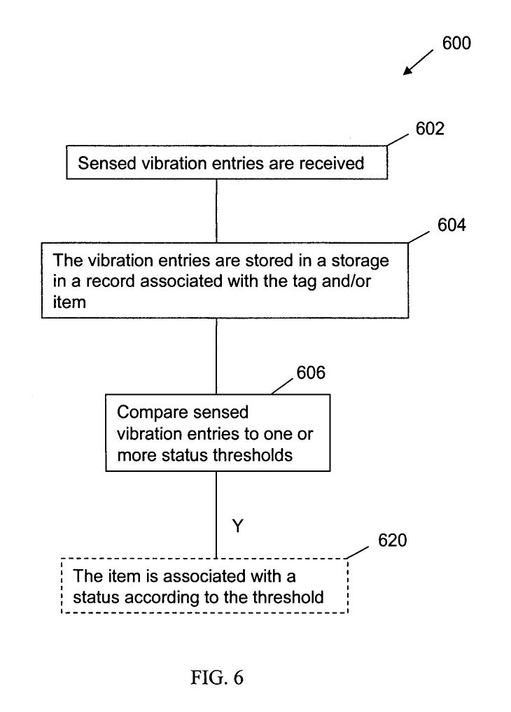

FIG. 6 shows a flowchart 600 providing example steps for tracking vibration information for an item via an RFID tag, according to an embodiment of the present invention. Other structural and operational embodiments will be apparent to persons skilled in the relevant art(s) based on the following discussion. Flowchart 600 is described with reference to the embodiment of FIG. 5. However, flowchart 600 is not limited to that embodiment. The steps shown in FIG. 6 do not necessarily have to occur in the order shown. The steps of FIG. 6 are described in detail below.

Flowchart 600 begins with step 602. In step 602, sensed vibration entries are received. For example in FIG. 5, vibration tracking module 508 receives sensed vibration entries from one or more readers 504a-504c.

In step 604, the vibration entries are stored in a storage in a record associated with the tag and/or item. For example, in FIG. 5, vibration tracking module 508 stores one or more vibration entries in memory 510 in a record associated with tag 400 and/or item 502.

A tag/item record in storage may have multiple vibration data entries. For example, an item may have a tag affixed to it on or around the time of manufacture. As the item moves through the supply chain to the retailer, multiple interrogations of the tag occur, most likely by different readers. During these reads, the tag may send sensed vibration data entries to the reader or readers. These vibration data entries may be stored as separate vibration entries associated with the tag. Alternatively, the vibration entries may be periodically accumulated.

In an embodiment, the vibration data is stored in a storage 506 of a reader 504. In addition or alternatively, vibration data is transmitted to an external tracking module such as vibration tracking module 508. The external tracking module may be associated with the manufacturer of the item to which the tag is attached. Alternatively, the external tracking module may be associated with a retailer, wholesaler, distributor, etc. of the item to which the tag is attached. The external tracking module may also be provided by a third party.

In step 606, one or more sensed vibration entries are compared to one or more status thresholds. For example, the sum of a set of sensed vibration entries may be determined. The sum represents the total vibrational forces experienced by a tag/item over the entire supply chain from manufacturer to retailer, over a portion of the supply chain, or over a specific period of time. The sum may then be compared to a set of thresholds. For example, an item may be designated as non-operational if the sum of a set of vibration entries exceeds a first threshold, as potentially damaged if the sum is between a second threshold and the first threshold, or as normal if the sum is below a third threshold.

Additionally or alternatively, individual vibration entries may be compared to a different set of thresholds. As discussed above, the cumulative effects of vibrations on an item may damage an item. In addition, a single excessive vibration may also damage an item. Therefore, individual sensor entries may be compared to one or more entries to determine the status of an item.

Note that different types of items may be associated with different thresholds. For example, plasma televisions may use a first set of thresholds whereas microwave ovens may use a second set of thresholds.

In optional step 620, a status is associated with an item based on results of threshold comparisons. For example, based on the comparison of step 606, vibration tracking module 508 may designate item 502 as non-operational, semi-operational, or functional, or a code such as designation 1, designation 2, etc. The set of thresholds described above and the associated status mappings may be user definable.

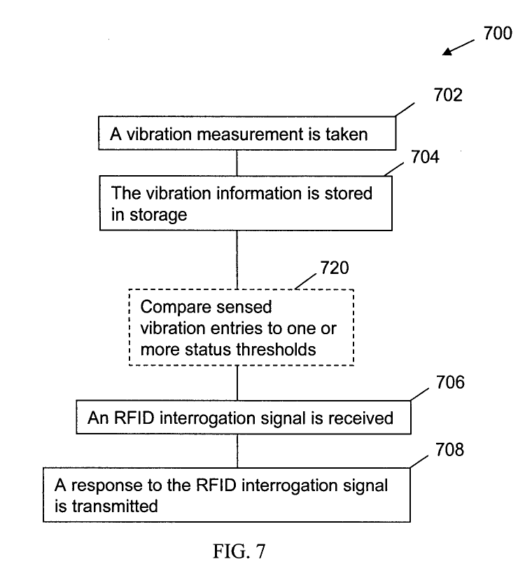

FIG. 7 shows a flowchart 700 of a method for obtaining sensed vibrations entries from an RFID tag associated with an item, according to an embodiment of the present invention. Other structural and operational embodiments will be apparent to persons skilled in the relevant art(s) based on the following discussion. Flowchart 700 is described with reference to the embodiment of FIG. 5. However, flowchart 700 is not limited to that embodiment. The steps shown in FIG. 7 do not necessarily have to occur in the order shown. The steps of FIG. 7 are described in detail below.

Flowchart 700 begins with step 702. In step 702, a vibration measurement is taken. For example, in FIG. 5, vibration sensor 406 measures a vibration of item 502 and outputs a corresponding signal. The output signal may then be sampled by sensor interface circuit 412.

In step 704, vibration information representative of the sensed vibration is stored. For example, in FIG. 5, storage 410 of tag 400 stores vibration information representative of a vibration measurement taken by vibration sensor 406. Subsequently, additional vibration information may be sensed and stored as separate entries in storage 410. Tag 400 may determine an average of a number of entries or series of averages and store the averages. Entry averages may take the place of the number of entries or may be stored in addition to the number of entries.

In optional step 720, one or more sensed vibration entries are compared to one or more status thresholds. For example, the sum of a set of sensed vibration entries may be determined. The sum represents the total vibrational forces experienced by a tag/item over the entire supply chain from manufacturer to retailer, over a portion of the supply chain, or over a specific period of time. In an embodiment where the sum is computed by a tag that has a limited storage, the sum may be computed every time the storage is substantially full. The sum may then be compared to a set of thresholds. For example, an item may be designated as non-operational if the sum of a set of vibration entries exceeds a first threshold, as potentially damaged if the sum is between a second threshold and the first threshold, and as normal if the sum is below a third threshold.

Additionally or alternatively, individual vibration entries may be compared to a different set of thresholds. For example, the cumulative effects of vibrations on an item may damage an item. In addition, a single excessive vibration may damage an item. Therefore, individual entries may be compared to one or more entries to determine the status of an item.

Note that different types of items may be associated with different thresholds. In the embodiment, the tag may be pre-programmed with one or more thresholds that correspond to characteristics of the associated device. For example, a tag that is to be associated with a plasma television may be programmed with a first set of thresholds whereas a tag to be associated with a microwave oven may be programmed with a second set of thresholds.

In step 706, an RFID interrogation signal is received.

In step 708, a response to the RFID interrogation signal is transmitted. The response to the RFID interrogation signal may include stored vibration entries, operations performed on the stored vibration entries, and/or the designated vibration status. For example, tag 400 may transmit an indication that item 502 has been designated non-operational. Alternatively, tag 400 may transmit the last x sensed vibration entries and/or an average of a set of vibration entries.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a tag interrogation can be automated by a computer system, as further described elsewhere herein. For example, a device may execute computer-readable instructions to cause a reader to transmit an RFID interrogation signal, store vibration information, designate an item as requiring repair, and/or to perform other operations described elsewhere herein.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for tracking vibrational information for an item via an RFID tag, comprising:
storing a plurality of vibration entries in a record associated with the RFID tag, wherein the vibration entries were received during interrogations of the RFID tag by one or more readers; and
determining a status of the item associated with the RFID tag based on at least one of the stored vibration entries.

2. The method of claim 1, wherein the determining step comprises:
determining a sum of a set of vibration entries stored for the RFID tag; and
comparing the sum to a threshold.

3. The method of claim 2, further comprising:
assigning a designation to the item if the sum exceeds the threshold.

4. The method of claim 2, further comprising:
determining whether the sum is within a predetermined range of values.

5. The method of claim 1, wherein the determining step comprises:
comparing a vibration entry in the plurality of stored vibration entries to a threshold; and
assigning a designation to the item if the vibration entry exceeds the threshold.

6. The method of claim 5, further comprising:
comparing the vibration entry to a second threshold; and
assigning a second designation to the item if the vibration entry is less than the second threshold.

7. The method of claim 1, further comprising:
receiving a first set of vibration entries for the RFID tag from a first reader; and
receiving a second set of vibration entries for the RFID tag from a second reader.

8. The method of claim 7, further comprising:
determining a sum including at least one vibration entry from the first set of vibration entries and at least one vibration entry from the second set of vibration entries; and
comparing the sum to a threshold.

9. The method of claim 8, further comprising:
determining if the sum is within a pre-determined range.

10. The method of claim 8, further comprising:
assigning a designation to the item if the sum exceeds the threshold.

11. An radio frequency identification (RFID) tag associated with an item, comprising:
a vibration sensor; and
an electrical circuit, including:
a sensor interface circuit configured to sample an output of the vibration sensor at a predefined frequency; and
a storage, wherein the storage is configured to store a plurality of entries, wherein each entry includes information corresponding to a sensed vibration.

12. The RFID tag of claim 11, further comprising:
a battery electrically coupled to the vibration sensor.

13. The RFID tag of claim 11, wherein the vibration sensor comprises a piezoelectric crystal.

14. The RFID tag of claim 11, wherein the electrical circuit further comprises:
a vibration processor configured to assign a designation to the item if a predefined criteria is met.

15. The RFID tag of claim 14, wherein the vibration processor is configured to assign a designation to the item if a sum of entries exceeds a threshold.

16. A system for tracking vibrational information for an item, comprising:
a vibration tracking module configured to receive a set of vibrational entries from an RFID reader, wherein the set of vibrational entries is read from an RFID tag associated with an item; and
a memory configured to store the received set of vibration entries;
wherein the vibration tracking module is configured to determine a status of the item based on at least one entry in the set of received entries.

17. The system of claim 16, wherein the vibration tracking module is configured to assign a designation to the item if a sum of entries in the set of entries exceeds a threshold.

18. The system of claim 17, wherein the vibration tracking module is configured to determine whether the sum is within a predetermined range of values.

19. The system of claim 16, wherein the vibration tracking module is configured to determine if a vibration entry exceeds a threshold.

20. A system for tracking vibrational information for an item, comprising:
means for storing a plurality of vibration entries in a record associated with the RFID tag, wherein the vibration entries were received during interrogations of the RFID tag by one or more readers; and
means for determining a status of the item associated with the RFID tag based on at least one of the stored vibration entries.
